(19) United States
(12) Patent Application Publication
(10) Pub. No.: US 2013/0132889 A1
(43) Pub. Date: May 23, 2013

(54) INFORMATION PROCESSING APPARATUS AND INFORMATION PROCESSING METHOD TO ACHIEVE EFFICIENT SCREEN SCROLLING

(71) Applicants: Masaaki Takayasu, Tokyo (JP); Yukari Shimozu, Tokyo (JP); Shinya Taniguchi, Tokyo (JP); Nobuharu Noto, Tokyo (JP)

(72) Inventors: Masaaki Takayasu, Tokyo (JP); Yukari Shimozu, Tokyo (JP); Shinya Taniguchi, Tokyo (JP); Nobuharu Noto, Tokyo (JP)

(73) Assignee: SONY COMPUTER ENTERTAINMENT INC., Tokyo (JP)

(21) Appl. No.: 13/611,241

(22) Filed: Sep. 12, 2012

(30) Foreign Application Priority Data
Nov. 22, 2011 (JP) 2011-255503

(51) Int. Cl. G06F 3/048

(52) U.S. Cl. 715/784

(57) ABSTRACT

In response to a content display start operation, an initial image is displayed on a display. When a user performs a scroll operation on a touch panel, monitored is whether or not a gap occurs between a first reference position set in an image to be displayed and a second reference position set on a screen associated with the first reference position. When no gap occurs, a display region is moved according to the scroll operation. When the gap occurs, the rate at which the display region moves to adjust the scroll is calculated based on the gap amount at each instant of time. And the displacement value resulting from the moving rate is added to the original position of the display region and then the display region is moved to the position. The displacement value continues to be added until the gap amount becomes zero.

### BACKGROUND OF THE INVENTION

1. Field of the Invention

The present invention relates to an information processing apparatus for processing information and simultaneously displaying the resulting images, as well as an information processing method employed by the information processing apparatus.

2. Description of the Related Art

Recent years have seen widespread use of small information devices intended for mobile use, such as mobile game devices, mobile phones, PDAs (personal digital assistants), and tablet terminals. These devices have been subject to a limited variety of input means because of their size limitations and their expected operability while they are carried around by a user. As a result, the input means and functions specialized in usage for such devices have been undergoing a development on their own.

To this end, a device capable of displaying and being input information thereon in the same region by placing a touch panel over a display has been commonly used in recent years. Provision of the touch panel like this allows the selection and movement of subjects such as icons and the page turning of a display screen image on a web page or document to be conducted as if an actual thing exists before the user even though those objects, documents and the like are merely present in the two-dimensional plane. Hence, this permits intuitive responses and operations.

On the other hand, in order to display a document or image containing vast amounts of information within a display size that facilitates viewing the characters and objects, part of the document or image must be displayed and scrolled up/down or left/rightward on the display having a limited area. The following may be conceivable as a scroll operation. A finger in contact with the touch panel or a pointer, on an image, operable by a pointing device with a page being displayed is moved to an arbitrary direction. As a result, a display region is moved so that the page moves in the same direction. In this manner, the user can feel the same sense of moving a page as when the page is actually moved and turned.

Such an environment that enables the scroll operations in an arbitrary direction involves also a problem where it is rather difficult to grasp the information in a comprehensive manner. More specifically, it is difficult to figure out where a region being displayed is exactly located in a page that the user is then reading. Also, it is difficult to determine to which direction the screen is to be scrolled to display a desired region. Also, it is difficult to recall or see the location where other information or images were or are than in the currently displayed region. In this manner, this free scroll operation achieved by using the touch panel or pointing device may lower the efficiency in obtaining the information as the case may be.

### SUMMARY OF THE INVENTION

The present invention has been made in view of the foregoing circumstances, and a purpose thereof is to provide a technology to support the scroll operation of a display image by the user.

One embodiment of the present invention relates to an information processing apparatus. The information processing apparatus includes: an operating information acquiring unit configured to acquire information regarding an indication point, inputted by a user, for an image displayed on a display and configured to detect a movement of the indication point as a scroll operation of a display image; a scroll control unit configured to move a display region according to the scroll operation when the scroll operation is detected, configured to monitor the occurrence of a positional difference between a first reference position set in an image to be displayed and a second reference position set on a screen associated with the first reference position, and configured to add a displacement value to the position of the display region toward such a direction that, if occurring, the positional difference therebetween is eliminated regardless of whether the scroll operation is in progress or not; and a display image generator configured to instantaneously generate an output image so that the display region moves according to the movement determined by the scroll control unit, and configured to display the generated output image on the display.

Another embodiment of the present invention relates to a method for processing information. The method for processing information includes: acquiring information regarding an indication point, inputted by a user, for an image displayed on a display and detecting a movement of the indication point as a scroll operation of a display image; moving the display region according to the scroll operation when the scroll operation is detected, monitoring the occurrence of a positional difference between a first reference position set in an image to be displayed and a second reference position set on a screen associated with the first reference position, and adding a displacement value to the position of the display region toward such a direction that, if occurring, the positional difference therebetween is eliminated, regardless of whether the scroll operation is in progress or not; and generating instantaneously an output image so that the display region moves according to a finally-determined movement, and displaying the generated output image on the display.

Optional combinations of the aforementioned constituting elements, and implementations of the invention in the form of methods, apparatuses, systems, computer programs, and so forth may also be practiced as additional modes of the present invention.

### BRIEF DESCRIPTION OF THE DRAWINGS

Embodiments will now be described by way of examples only, with reference to the accompanying drawings which are meant to be exemplary, not limiting, and wherein like elements are numbered alike in several Figures in which:

FIG. 1 illustrates an example of the appearance of an information processing apparatus according to an embodiment of the present invention;

FIG. 2 illustrates a detailed structure of an information processing apparatus according to an embodiment;

FIG. 3 is a diagram to explain a method for controlling the scrolling of a display image in an embodiment;

FIG. 4 illustrates an exemplary screen used when reference positions are set to adjust the scrolling in an embodiment;

FIG. 5 is a diagram to explain a process performed when a scroll adjustment operation is used for the positioning of a focus point in an embodiment;

FIG. 6 is a diagram to explain another example when a scroll adjustment operation is used for the positioning of a focus point in an embodiment; and

FIG. 7 is a flowchart showing a processing procedure where an information processing apparatus controls the scrolling of a display image in an embodiment.

### DETAILED DESCRIPTION OF THE INVENTION

The invention will now be described by reference to the preferred embodiments. This does not intend to limit the scope of the present invention, but to exemplify the invention.

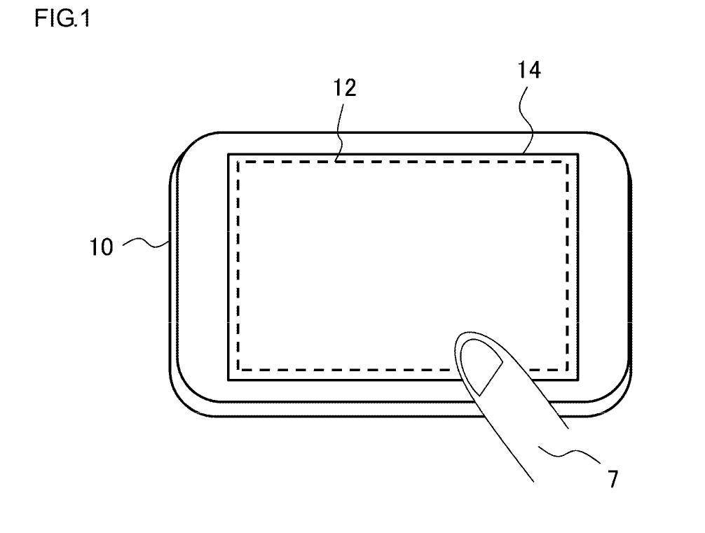

FIG. 1 illustrates an example of the appearance of an information processing apparatus according to an embodiment of the present invention. The information processing apparatus may be any one of a mobile phone, a portable digital assistant (PDA), a mobile game device, a tablet terminal, and the like that are each provided with a display function and the other information processing functions in an integrated fashion. Alternatively, a device having the appearance like that of the information processing apparatus 10 as shown in FIG. 1 may be a unit used for display and input purposes, and the remaining information processing functions may be provided in a separate casing that connects to said unit. The information processing apparatus 10 may be provided with various types of mechanism and components according to the functions. Since a known art may be used for such mechanisms and components, the description thereof will be omitted as appropriate.

The information processing apparatus 10 is structured such that the a display 14 is placed in front of the body of the information processing apparatus 10 and the top surface is covered with a touch panel 12. The components required for various information processings such as a CPU, a graphics processor, an audio processor, and a memory (all of which are not shown in FIG. 1) are incorporated into the back side of the display 14. The display 14 may be any one of a liquid crystal display, an electro luminescent display (ELD), a plasma display and the like which are commonly used today.

The touch panel 12 may implement any of a resistive overlay method, an optical method, an electrostatic capacitance coupling method, and the like which are in practical use. The touch panel 12 detects a contact point by a finger 7 or a stylus pen. The information processing apparatus 10 may further comprise a speaker for outputting audio, an earphone connection terminal, an infrared port or wireless LAN (Local Area Network) feature used to communicate with other devices, a battery box, and the like all of which are omitted in FIG. 1. The display 14 displays a menu screen or a screen including an icon for the input of a user's operation, a game screen, a moving-image playback screen, a text display screen, a still-image display screen or the like which indicates the results of information processings, according to the functions of the information processing apparatus 10.

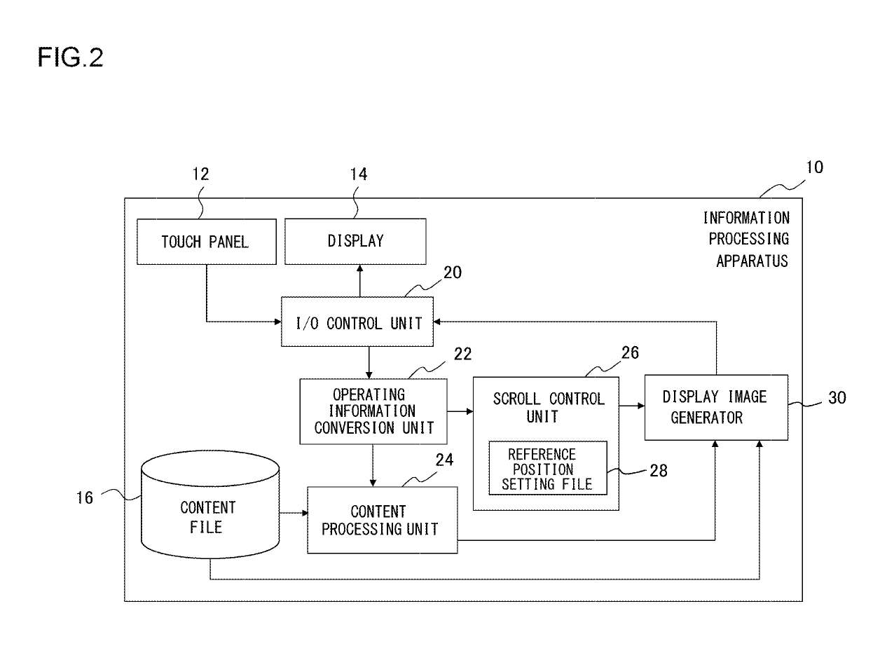

FIG. 2 illustrates a detailed structure of an information processing apparatus 10. In addition to the aforementioned touch panel 12 and the display 14, the information processing apparatus 10 includes a content file storage 16 for storing programs and various data for contents, an input/output (I/O) control unit 20 for controlling the receiving of signals inputted from the touch panel 12 and the output of image data to the display 14, an operating information conversion unit 22 for converting an input signal from the touch panel 12 into information regarding an operation input, a content processing unit 24 for processing a content according to the operation input, a scroll control unit 26 for controlling the scrolling of an image, and a display image generator 30 for generating a display image.

In FIG. 2, the structural components described as functional blocks that perform various processings may be implemented hardwarewise by elements such as a CPU (Central Processing Unit), memory and other LSIs, and softwarewise by image processing programs or the like. Therefore, it will be obvious to those skilled in the art that the functional blocks may be implemented by a variety of manners including hardware only, software only or a combination of both and should not be considered as limiting.

The input/output control unit 20 connects to the touch panel 12 and the display 14 and controls the input/output of data using a commonly-used method. The input signal received from the touch panel 12 indicates the coordinates of a contact point at which the user touches on the touch panel 12, a movement (travel) path of the coordinates when the contact point moves continuously, and the like. A method for detecting the contact point on the touch panel 12 differs depending on the employed detecting system and therefore the description thereof is not given here. The input/output control unit 20 also outputs a video signal for a displayed image to the display 14.

The content file storage 16 stores various types of data required for carrying out the information processing regarding the displaying of content according to the user's operation by using the touch panel. The “content” as used herein may be computer games, movies, music, novels, photographs, maps, web pages, and so forth; the types thereof and the path through which data is stored are not limited to any specific ones so long as the subjects thereof can be expressed after electronic processing. Also, the embodiments of the invention can be applied not only to general “content” but also to the general information processing for communications, schedule management, address list, spreadsheet, and the like. In the following description, all of general “content” together with such entities will be collectively referred to as the “content”.

If, for example, the content is a game, the content file storage 16 stores the program for the game, information on a player or players, information on the achievement level (score) attained at the previous game play, and so forth. If the content is a movie or music, the content file storage 16 stores video data or audio data that has been compressed and coded, a program used to decode and playback the video data or audio data, and so forth. The content file storage 16 may be a hard disk drive or a combination of a removable recording medium (e.g., memory card, ROM disk, optical disk or magneto-optical disk) and a readout system compatible with the removable recording medium.

The operating information conversion unit 22 acquires from the input/output control unit 20 an input signal fed from the touch panel 12 and identifies the operation input intended by the user based on the coordinates of a contact point contained in the input signal. If, for example, a GUI (Graphical User Interface) is displayed in a screen as an on-screen display, an operation input corresponding to the GUI which is a target of a touch will be identified based on the correspondence relation between the coordinates of the contact point and the GUI position, and then convey the thus identified operation input to the content processing unit 24.

When one contact occurs on the displayed image excluding the GUI and this contact point moves, the operating information conversion unit 22 perceives the movement of the contact point as a scroll operation and conveys a temporal change in the position of the contact point to the scroll control unit 26. At this time, the coordinates of the contact point on the touch panel is converted into values of screen coordinate system if needed.

The scroll control unit 26 controls the scrolling of a display image based on the thus conveyed temporal change in the position of the contact point. Basically, the position of the contact point on an image when the contact has occurred is identified, and a display region on the image is determined in such a manner that the position thereof follows the coordinates of the contact point moving in the screen coordinate system. The display region is sequentially determined according to the output frames of the display 14, for instance.

Further, the scroll control unit 26 monitors a gap amount between a first reference position set in an image to be displayed and a second reference position set on the screen of the display 14 associated with the first reference position, and automatically adds a movement associated with the gap amount when the display region is determined. Though its details will be discussed later, a movement of the display region is added toward a direction in such a manner as to eliminate the gap as long as the gap exists, irrespective of whether the user is performing the scroll operation or not. As a result, during a scroll operation, a displacement caused by the movement is added to the position of the display region determined by the scroll operation.

The scroll control unit 26 stores, in an internal memory or the like, a reference position setting file 28 describing a combination of the first reference position of an image and the second reference position of the screen, the gap therebetween to be detected, and a condition to determine whether a gap exists. The reference position setting file 28 which has been provided together with the content files stored in the content file storage 16 may be read out and stored in the internal memory.

The content processing unit 24 performs processings necessary for the content output such as the progress of a game and the playback of moving images and music according to an operation input by use of programs and image data stored in the content file storage 16. More specifically, the existing technology may be used for a specific procedure depending on the content. The display image generator 30 generates image data to be outputted, in accordance with a request from the content processing unit 24 or the scroll control unit 26 and then outputs the thus generated image data to the input/output control unit 20. The image generated by the display image generator 30 is an image to be newly displayed as a result of the processing by the content processing unit 24 or an image whose display region has been moved to a region determined by the scroll control unit 26.

In the former case, the display image generator 30 renders a new image by, for example, reading out necessary image data from the content file storage 16 according to an instruction given from the content processing unit 24. In the latter case, the display image generator 30 receives the information on a display region from the scroll control unit 26 and moves a region to be rendered, using a known art. The image thus generated is stored in a frame buffer in the input/output control unit 20 and is displayed on the display 14 when the image is outputted to the display 14, with the suitable timing, from the input/output control unit 20.

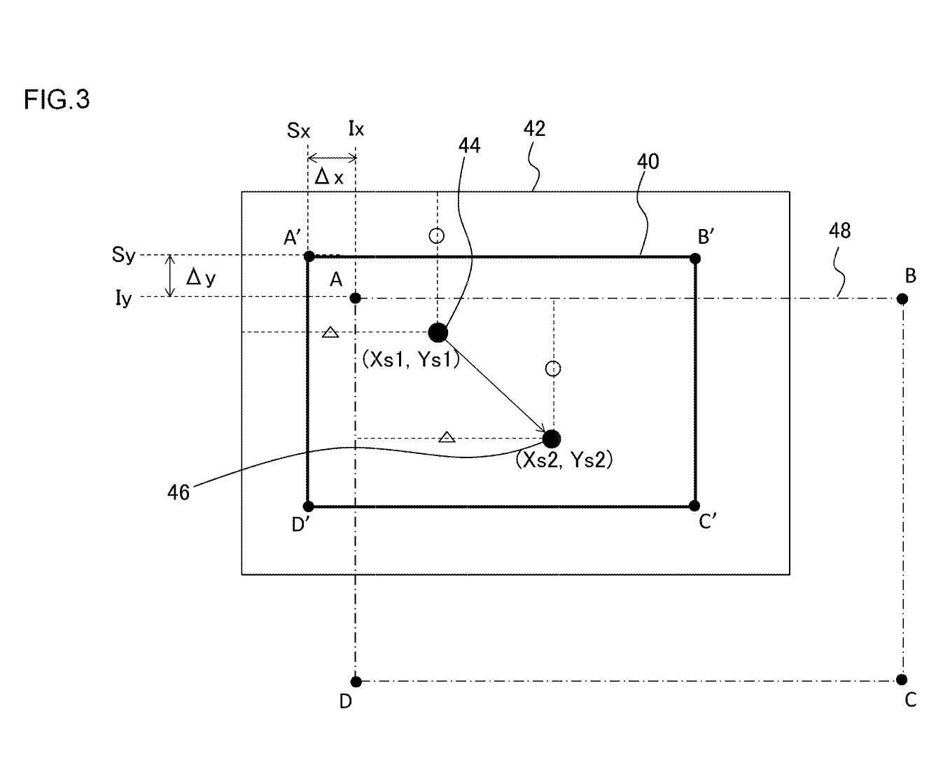

FIG. 3 is a diagram to explain a method, for controlling the scrolling of a display image, employed by the scroll control unit 26. Suppose that a display region 40 is displayed in an image 42 to be subjected to display. Suppose also that, in this state, the user's contact occurs with a point 44 on the screen being a starting point and then the contact point moves until it reaches an ending point 46. As the coordinates (Xs1, Ys1) of the starting point 44 is notified from the operating information conversion unit 22, the scroll control unit 26 converts the coordinates thereof into those on the image 42. These coordinates correspond to the length of broken line marked with a triangle and the length of broken line marked with a circle in FIG. 3.

Then, the display region 40 is moved so that the coordinates of the starting point on the image 42 follows the movement of the contact point from the starting-point coordinates (Xs1, Ys1) to the ending-point coordinates (Xs2, Ys2) on the screen. As a result, the positional relationship between an image after the movement of the contact point and the display region is shown as an image 48 and the display region 40 in FIG. 3. This means that the contact point is fixed regarding it as the coordinates on the image 42. For the illustrative purpose and in order to associate a region on the screen with the display region, it is shown in FIG. 3 that the display region 40 is fixed and an image is moved relative to the display region 40.

In this manner, the position of the display region 40 is determined at each instant of time corresponding to an output frame. Thus, the image can be scrolled by an expression where the display image is moved as if the display image is being pressed with a finger or the like in contact with the touch panel 12. In this example, when the contact point has reached the ending point 46, the display region 40 is located such that the display region 40 strays from the upper end and the left end of the image 48. A portion of the display region 40 that strays or protrudes from the original image has no proper image data therein and therefore the portion thereof is displayed as a blacked-out portion or a predetermined background image.

In the present embodiment, a marginal region having a predetermined width is provided in this manner around an image to be displayed. And if the display region strays into the marginal region, a movement by which the display region is returned to a display image side is added. This scroll adjustment processing is carried out, irrespective of whether the user is performing a scroll operation or not, or the user is touching the touch panel 12 or not. This processing not only eliminates a sudden event or the like feeling of a sudden stoppage of the screen after the screen has reached the edge of the image during a scroll operation, but also supports the recovery of the display region from the marginal region, which is meaningless to display, with a naturally smooth movement.

To determine a movement which is to be added, the gap amount between the first reference position set in an image and the second reference position set on a screen is used. The first reference position set in an image in this case is associated with four sides (edges) of a rectangular image (e.g., the sides (edges) AB, BC, CD, and DA in the image 48). And the second reference position is associated with four sides A′B′, B′C′, C′D′, and D′A′ of a rectangular screen corresponding respectively to the relatively identical four sides AB, BC, CD, and DA of the image; the four sides of a rectangular screen constitute the display region 40 with vertices A′, B′, C′, and D′. If the second reference position of the screen is outside of the image, it will be determined that a gap occurs and then the distance between the corresponding reference positions will be acquired as the gap amount.

Since, for example, the side A′B′ and side D′A′ are outside of the image 48, a distance Δy between the position Sy of the side A′B′ and the position Iy of the side AB of the image 48 and a distance Δx between the position Sx of the side D′A′ and the position Ix of the side DA of the image 48 are obtained. The reference positions may be straight lines as shown in FIG. 3 and the distances in the directions vertical to them may be obtained as the gap amounts. Or the reference positions may be set as points such as vertices A, B, C, and B, and the distances between corresponding vertices may be set as the gap amounts.

Then, the larger the gap amount is, the faster (or the more accelerating) the display region is moved in the directions where the respective reference positions of the image and the screen coincide with each other. More specifically, the gap amount is acquired at each instant of time corresponding to a frame outputted, thereby the rate at which the display region is supposed to move between the frames is calculated, and a display region at the next instant of time is determined. For example, a velocity vector (Vx(t), Vy(t)) at each time t is determined using the following equations.

Vx(t)=kx×Δx(t)

Vy(t)=ky×Δy(t)

In the above equations, kx and ky are constants.

Then, a displacement owing to a scroll adjustment operation defined by the aforementioned velocity vector is added to the original positional coordinates of the display region, thereby determining the positional coordinates of the display region at each instant of time. Here, the “original positional coordinates” are the positional coordinates of the display region that follow the movement of the contact point if the scroll operation is in progress. And while no scroll operation is performed or the contact point is at rest, the “original positional coordinates” are those of the display region at the time. As a result, the positional coordinates (x(t), y(t)) of the display region at time t (e.g., the coordinates of a top-left point) are expressed as follows if the original positional coordinates of the display region is denoted (x′(t), y′(t)) and the time interval between frames is denoted Δt.

x(t)=x′(t)+Vx(t−1)Δt

y(t)=y′(t)+Vy(t−1)Δt

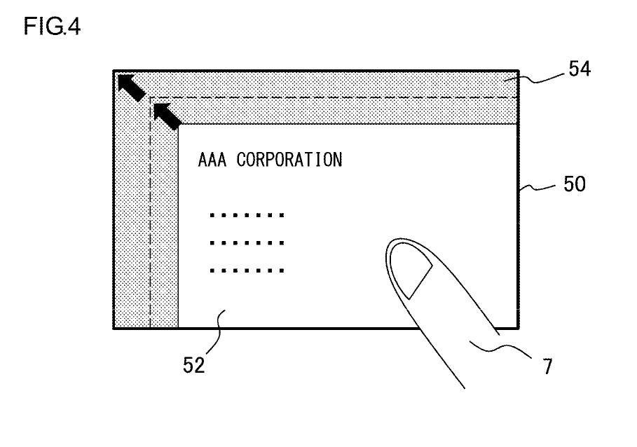

FIG. 4 illustrates an exemplary screen used when the reference positions are set to adjust the scrolling as described above. Assume herein that an image 52 such as a web page is displayed on a screen 50 shown in FIG. 4. If a scroll operation using a finger 7 is done toward a diagonally downward right direction with the result that the display region is off the image 52, a marginal region 53, which is blacked out, for instance, will be displayed. Even though, in this state, the finger 7 remains in contact with the touch panel, the display region moves in a direction such that the above-described reference positions coincide with each other, namely in such a direction as to eliminate the marginal region 54.

Even if the scroll operation using the finger 7 continues in the opposite direction to that of the scroll adjustment operation and if the speed of the scroll operation is less than the speed of the scroll adjustment operation, the display region will move in such a direction as to eliminate the margin region 54. That is, the movement of the image 52 relative to the screen 50 occurs in the direction shown by the arrows in FIG. 4. As a result, the margin region 54 disappears. And if the upper end and the left end of the image 52 coincide with those of the screen 50, respectively, the gap amount in each reference position becomes zero and therefore the scroll adjustment operation will stop.

It should be noted here that the rules or methods by which to determine the movement of the display region based on the gap amounts are not limited to the above-described functions. For example, a linear function added with intercepts, a quadratic function, or a higher-order function whose degree is three or more may also be used. The acceleration may be determined using such a function. That is, any appropriate function may be used so long as it can work to strengthen the scroll adjustment operation when the gap amount increases.

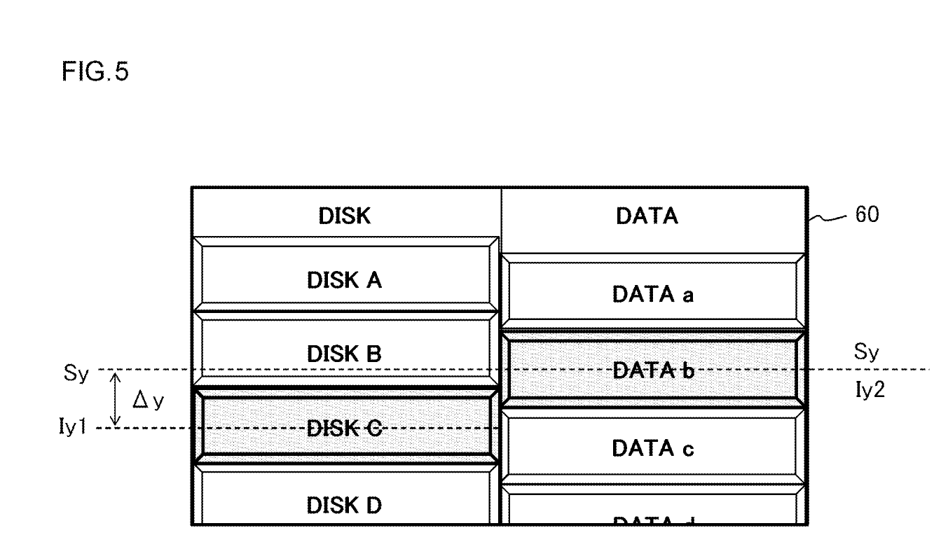

In the examples of FIG. 3 and FIG. 4, the scroll adjustment is used in the case where the screen strays from the image but the present embodiments are not limited thereto. FIG. 5 is a diagram to explain a process performed when the scroll adjustment operation is used for the positioning of a focus point. In FIG. 5, two columns each showing “Disk” and “Data” are displayed on a screen 60. Options for “Disk” which include “Disk A”, “Disk B”, “Disk C”, “Disk D”, . . . , are arranged in the column of “Disk”, whereas options for “Data” which include “Data a”, “Data b”, “Data c”, “Data d”, . . . , are arranged in the column of “Data”. They are indicated by button-shaped GUIs.

The buttons belonging to each column are arranged on such the screen 60, and those buttons and the other buttons similarly arranged but located off-screen are sequentially moved vertically by a scroll operation on the touch panel 12. As a selection input is effected by a short contact to any of the buttons, the selected button(s) is/are displayed as an object/objects to be selected in an emphasized manner. In the example of FIG. 5, “Disk C” and “data b” are highlighted. However, since the scroll operation is enabled, the buttons selected may possibly be located in various positions in the vertical direction.

In this embodiment, when the selection input is effected, the scroll adjustment is made such that the selected button is displayed in a predetermined position such as the center in the vertical direction of a screen. Thus, the selected button eventually returns to a predetermined position even if the free scroll operation is done after the selection. Hence, inconvenience caused by an event where the user lost track of the button does not occur. Also, if different columns are displayed side by side as shown in FIG. 5, the selected buttons are displayed at the same height, so that the grasp of all of the selected buttons and the comparison can be easily achieved.

In such a mode of carrying out the present embodiment, a reference position is set at a vertically central position of each of the buttons available to choose from, and a reference position Sy associated with said reference position is set at a vertically central position of the screen. When a selection input is entered, the reference position of the selected button is made valid and a gap amount between the reference position of the button and the reference position Sy of the screen is obtained. In this mode of carrying out the present embodiment, the gap amounts are acquired, in either case where the reference position of the selected button located above or below the reference position Sy of the screen so as to adjust the scroll.

In the example of FIG. 5, the button “Data b” has undergone the scroll adjustment or the like and therefore the reference position Iy2 agrees with the reference position Sy of the screen. In contrast thereto, the reference position Iy1 of the button “Disc C” is displaced from the reference position Sy of the screen by Δy on the lower side. Thus, the speed (i.e., the rate at which the display region moves) or acceleration is determined in the same manner as described in connection with FIG. 3. In this case, the scroll adjustment is made such that the arrangement of buttons in a single column only, instead of entire display region, is moved upward according to the thus determined speed or acceleration.

As already mentioned, even if the scroll operation is in progress at this stage, the scroll adjustment operation is performed irrespective of the scroll operation, and the position of the button at each instant of time is determined based on the sum of the scroll operation and the scroll adjustment operation. The example of FIG. 5 shows the screen where two columns, each of which has buttons arranged vertically, are placed side by side laterally. However, the present embodiments are not limited thereto and, for example, the screen may be such that there are two rows each of which has buttons arranged horizontally or there may be one column (row) or more than three columns (rows). Further, the scroll operation may be performed in a single direction only or performed such that the movement in arbitrary directions is allowed and a focus point on the image, such as button, is returned to a position, such as the center of the screen, expressed by the two dimensional coordinates. The adjustment operation in two dimensional space can be achieved as mentioned above.

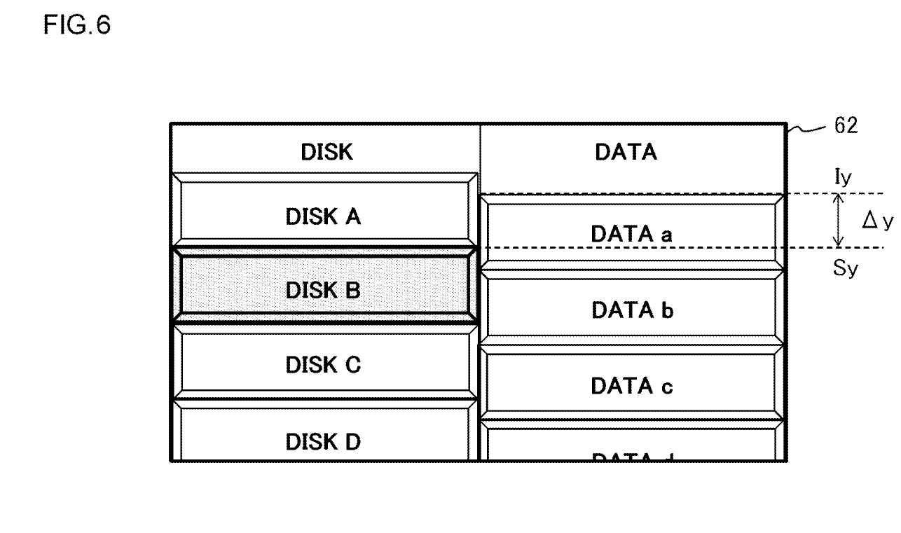

FIG. 6 is a diagram to explain another example when the scroll adjustment operation is used for the positioning of a focus point. Similar to the screen 60 of FIG. 5, a screen 62 is configured to have two columns of “Disk” and “Data” and each column is scrolled vertically. Assume here that the information represented by the left column and the information represented by the right column have a parent-child relationship. For example, data stored in a disk selected on the column of “Disk” is displayed in the column of “Data”. In FIG. 6, the button “Data B” is highlighted as an selected object (button), and the buttons “Data a”, “Data b”, “Data c”, . . . are displayed as data stored therein.

In this example, the position of the button “Disk B”, which is a parent and has been selected in the column of

“Disk”, is not adjusted and the corresponding position in the screen is set as a reference position of the screen for buttons arranged for “Data” which is a child. In other words, the reference position of the screen for the column of “Data” is varied according to the position of a button selected in the column of “Disk”. For example, the upper end of the button “Disk B” which is the selected object is set as a reference position Sy of a screen, and the upper end of the “Data” column, namely the upper end of the uppermost button “Data a” is set as a reference point Iy of an image.

Similar to FIG. 5, in either case where the reference position Iy of the image is located, below or above, relative to the reference position Sy of the screen, it will be determined that a gap occurs and the scroll adjustment will be made. In FIG. 6, the reference position Iy of the button “Data a” is displaced from the reference position Sy of the screen by Δy on the upper side. Thus, the speed (i.e., the rate at which the display region moves) or acceleration is determined in the same manner as described in connection with FIG. 3, and the scroll adjustment is made such that the arrangement of buttons in the “Data” column only is moved downward according to the thus determined speed or acceleration.

As a result, even if either one of the columns is scrolled in whatever way, the uppermost button of the child column will return to the same position of a selected button in the parent column. In this manner, various information such as a parent-child relationship of data can be expressed by the display position on the screen when the reference position on the screen is not fixed but dynamically determined according to a user's input or the like. For example, the reference position Sy of the screen in the example of FIG. 5 may be moved according to the user's input. In such a case, a column comprised of an arrangement of buttons, serving as parent data, which determines the reference position Sy of the screen may be further displayed on the screen.

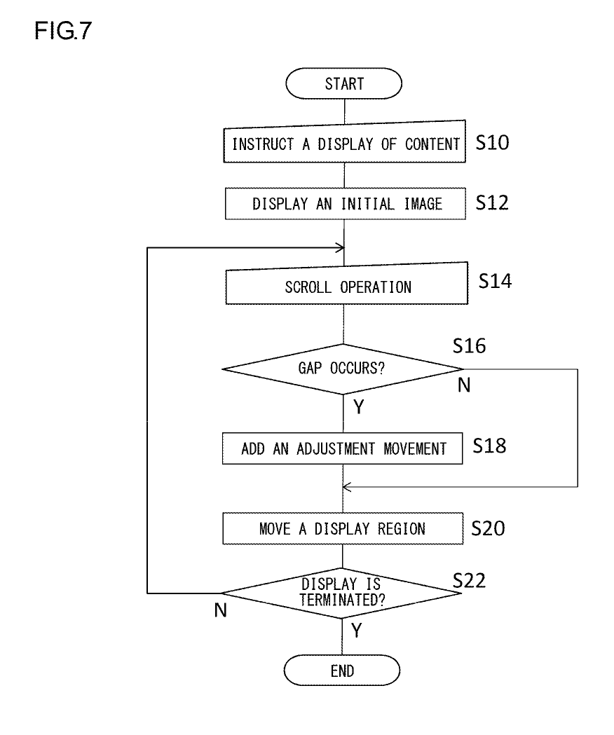

A description is now given of an operation of the information processing apparatus 10 achieved by the above-described structure. Since the information processing and image display processing other than the processing related to the scrolling of an image may be conceivable in various manners depending on the content and operation, and are executed as appropriate using a general technique, a description thereof is omitted here. FIG. 7 is a flowchart showing a procedure, for controlling the scrolling of a display image, performed by the information processing apparatus 10. As the user first enters, via the touch panel 12, an instruction to start a display by selecting a content from a menu screen displayed on the display 14 (S10), the content processing unit 24 and the display image generator 30 read out necessary data from the content file storage 16 and cause a display of an initial image on the display 14 (S12).

As the user performs a scroll operation on the touch panel 12 in this state (S14), the scroll control unit 26 monitors whether or not a gap occurs between the first reference position set in an image to be displayed and the second reference position set on the screen associated with the first reference position (S16). As already explained in connection with FIG. 3, there are cases where, even though there occurs a gap, it is not determined that there is such a gap due to the direction, depending on a condition set by the reference position setting file 28. In the mode shown in FIG. 5, the occurrence of a gap may be monitored through a button selection operation instead of the scroll operation performed in Step S14.

If no gap occurs (N of S16), the display region will be moved so that the position in the image, which corresponds to the start point of the contact, follows the movement of the contact point on the touch panel 12 (S20). If, on the other hand, a gap occurs (Y of S16), the rate at which the display region is supposed to move to adjust the scroll will be sequentially calculated based on the gap amount at each instant of time. Then a displacement caused by the movement rate of the display region is added to the original position of the display region by the scroll operation (S18) and the display region is moved to the position (20). The process of Step S18 is carried out at each instant of time during the occurrence of the gap irrespective of whether the scroll operation of Step S14 continues or not.

In practice, the scroll control unit 26 may include a structure where the display region is moved by a scroll operation and a structure where a scroll adjustment operation is activated, which are provided independently from each other. In this case, a concept where a displacement for adjustment is added to the original position of the display region is technically nonexistent but the finally obtained display region is effected by the movement added with the displacement. Alternatively, a similar movement is obtained as follows. That is, first, the displacement effected by the scroll adjustment operation is added to the primary shift amount of the display region caused by the scroll operation with the result that the shift amount in which the adjustment operation has already been incorporated is calculated. Then the thus calculated shift amount is added to the display region at the previous time. Thereafter, while no instruction to terminate the display is entered (N of S22), the processes from Step S16 to Step S20 are repeated according to the scroll operation of Step 14. Then if the instruction to terminate the display is entered, the processing is terminated (Y of S22).

By employing the above-described embodiments, the reference positions corresponding to the screen and an image to be displayed are set; if a scroll operation by the user causes the reference positions to have a gap amount therebetween, a movement will be added to the display region toward a direction such that the gap amount is eliminated. For example, a marginal region is provided around the image to be displayed; if the marginal region is contained in the display region, it will be determined that a gap occurs, and then a movement is added so that the display region can return to a position where the image is located. As a result, even though the user performs a scroll operation without recognizing the edges of the image, a sudden event or the like feeling of sudden stoppage of the display region at the edge of the image can be eliminated.

Also, the larger the gap amount is, faster the speed at which the display region returns is set. Thereby, the display region is more likely to return to the original position in the middle of a scroll operation even if the user rapidly carries out the scroll operation unexpectedly in a direction where the marginal region increases. As a result, while a free scroll operation is permitted, inconvenience caused by the events where an unnecessary region is displayed for a long time or the user lost the track of the present display position can be suppressed from occurring. Thus, the images can be efficiently displayed.

Similar reference positions may be set to a focus point in an image, such as a selected GUI, and a position on a screen where the focus point is to be displayed. Thereby, the focus point can be eventually returned to a predetermined position even if any scroll operation is done. As a result, losing the track of the focus point can be eliminated, and if there are a plurality of focus points, the positions of the focus points can be easily adjusted.

The present invention has been described based upon illustrative embodiments. The above-described embodiments are intended to be illustrative only and it will be obvious to those skilled in the art that various modifications to the combination of constituting elements and processes could be developed and that such modifications are also within the scope of the present invention.

For example, in the above-described embodiments, a user's contact operation to the touch panel is detected as input information. The input information is not necessarily the contact operation to the panel so long as the user can enter the position on an image as an indication point. For example, a scroll operation may be performed by operating on a pointer, an icon or the like displayed on the display screen by a pointing device such as a mouse, a trackball, a track pad, and a joystick. The scroll operation in such a case may be done in a general mode where, for example, the pointer is moved by moving the pointing device with pressed down on a predetermined button provided in it. And the indication point that moves in this manner is treated in the same way as the contact point in the above-described embodiments and thereby the same advantageous effects as those of the above-described embodiments can be achieved.

What is claimed is:

1. An information processing apparatus comprising:
an operating information acquiring unit configured to acquire information regarding an indication point, inputted by a user, for an image displayed on a display and configured to detect a movement of the indication point as a scroll operation of a display image;
a scroll control unit configured to move a display region according to the scroll operation when the scroll operation is detected, configured to monitor the occurrence of a positional difference between a first reference position set in an image to be displayed and a second reference position set on a screen associated with the first reference position, and configured to add a displacement value to the position of the display region toward such a direction that, if occurring, the positional difference therebetween is eliminated regardless of whether the scroll operation is in progress or not; and
a display image generator configured to instantaneously generate an output image so that the display region moves according to the movement determined by the scroll control unit, and configured to display the generated output image on the display.

2. The information processing apparatus according to claim 1, wherein, the scroll control unit determines the displacement value, toward the direction, that cancels out the positional difference therebetween in such a manner that the larger the positional difference between the first and second reference positions is, the greater the rate at which the display region moves will be.

3. The information processing apparatus according to claim 1, wherein, of reference positions set in respective graphical user interfaces (GUIs) that indicate options available for the image to be displayed, the scroll control unit validates a reference position set in a graphical user interface selected by the user, and
wherein the scroll control unit monitors the occurrence of a positional difference between the reference position set in the GUI selected by the user and the second reference position set on the screen.

4. The information processing apparatus according to claim 1, wherein the scroll control unit monitors the occurrence of a positional difference between a reference position set on an edge of the image to be displayed and a reference position set on the screen corresponding to said edge of the image, and
wherein, when the reference position set on the screen is outside of the image to be displayed, the positional difference is determined to occur.

5. The information processing apparatus according to claim 1, wherein the scroll control unit allows the second reference position set on the screen to vary as based on input from the user.

6. The information processing apparatus according to claim 3, wherein the image to be displayed is comprised of a plurality of arrangements of graphical user interfaces (GUIs) that individually scroll in the same direction, and
wherein the scroll control unit monitors the occurrence of a positional difference between a reference position set on a GUI selected for each arrangement of the GUIs and the second reference position on the screen, which is set in common to all arrangements of the GUIs, and adds a displacement value toward such a direction that the positional difference therebetween is eliminated for each arrangement thereof.

7. The information processing apparatus according to claim 3, wherein the image to be displayed is comprised of a plurality of arrangements of graphical user interfaces (GUIs) that individually scroll in the same direction, and
wherein the scroll control unit sets a position of a GUI selected in a predetermined arrangement as the second reference position on the screen, monitors the occurrence of a positional difference between a reference position set on a GUI selected for each of the other arrangements of the GUIs and the second reference position thus set, and adds a displacement value toward such a direction that the positional difference therebetween is eliminated for each of the other arrangements so that the selected GUIs in respective arrangements are aligned.

8. A method for processing information, the method comprising:
acquiring information regarding an indication point, inputted by a user, for an image displayed on a display and detecting a movement of the indication point as a scroll operation of a display image;
moving the display region according to the scroll operation when the scroll operation is detected, monitoring the occurrence of a positional difference between a first reference position set in an image to be displayed and a second reference position set on a screen associated with the first reference position, and adding a displacement value to the position of the display region toward such a direction that, if occurring, the positional difference therebetween is eliminated, regardless of whether the scroll operation is in progress or not; and
generating instantaneously an output image so that the display region moves according to a finally-determined movement, and displaying the generated output image on the display.

9. A computer program embedded in a non-transitory computer-readable medium, the program comprising:
an operating information acquiring module operative to acquire information regarding an indication point, inputted by a user, for an image displayed on a display and operative to detect a movement of the indication point as a scroll operation of a display image;
a scroll control module operative to move a display region according to the scroll operation when the scroll operation is detected, operative to monitor the occurrence of a positional difference between a first reference position set in an image to be displayed and a second reference position set on a screen associated with the first reference position, and operative to add a displacement value to the position of the display region toward such a direction that, if occurring, the positional difference therebetween is eliminated regardless of whether the scroll operation is in progress or not; and
a display image generating module operative to instantaneously generate an output image so that the display region moves according to a finally-determined movement, and operative to display the generated output image on the display.

10. A non-transitory computer-readable medium encoded with a computer program executable by a computer, the computer program comprising:
an operating information acquiring module operative to acquire information regarding an indication point, inputted by a user, for an image displayed on a display and operative to detect a movement of the indication point as a scroll operation of a display image;
a scroll control module operative to move a display region according to the scroll operation when the scroll operation is detected, operative to monitor the occurrence of a positional difference between a first reference position set in an image to be displayed and a second reference position set on a screen associated with the first reference position, and operative to add a displacement value to the position of the display region toward such a direction that, if occurring, the positional difference therebetween is eliminated regardless of whether the scroll operation is in progress or not; and
a display image generating module operative to instantaneously generate an output image so that the display region moves according to a finally-determined movement, and operative to display the generated output image on the display.
